(19) United States
(12) Patent Application Publication
(10) Pub. No.: US 2024/0375676 A1
(43) Pub. Date: Nov. 14, 2024

(54) DRIVING CONTROL SYSTEM

(71) Applicant: SUBARU CORPORATION, Tokyo (JP)

(72) Inventor: Hajime OYAMA, Tokyo (JP)

(21) Appl. No.: 18/250,290

(22) PCT Filed: Nov. 4, 2021
(86) PCT No.: PCT/JP2021/040685

§ 371 Date: Apr. 24, 2023

(51) Int. Cl. B60W 60/00

(52) U.S. Cl. CPC B60W 60/001; B60W 2420/403; B60W 2420/408; B60W 2756/10

(57) ABSTRACT

A driving control system includes: a sensor group for executing a driving assist; an automated driving control information generator that includes an automated driving sensor for executing an automated driving control, and generates information to be used for the automated driving control; a surrounding information generator that executes a communication connecting an own vehicle and everything, transmits automated driving sensor information of the own vehicle, and acquires automated driving sensor information of another vehicle to generate information on a surrounding of the own vehicle by the acquired information and a high-precision map; and a controller that executes the automated driving control or a driving assist control. The controller changes a mode of a driving control in response to an operation state of the sensor group, the automated driving control information generator, or the surrounding information generator.

### CROSS-REFERENCE TO RELATED APPLICATIONS

This application is the U.S. National Phase under 35 U.S.C. § 371 of International Application No. PCT/JP2021/040685, filed on Nov. 4, 2021.

### TECHNICAL FIELD

The invention relates to a driving control system.

### BACKGROUND ART

In recent years, an automated driving vehicle that allows a driver to travel the vehicle without performing a driving operation have been developed. This automated driving control is defined in six stages including level 0, level 1 (assisted driving), level 2 (partially automated driving), level 3 (conditional automated driving), level 4 (highly automated driving), and level 5 (full driving automation). The development of the automated driving control is proceeding rapidly toward the final stage.

As a device of this type, advanced systems and methods have been disclosed for automated driving that process a very large amount of data from a camera, a radar, LIDAR, and an HD map in generating commands for controlling a vehicle in real time, safely, and comfortably to facilitate automated driving functions, including platforms for automated driving levels 3, 4, and/or 5. More specifically, an end-to-end platform has been disclosed with a flexible architecture that provides diversity and redundancy, including an architecture for an automated driving vehicle which utilizes a computer vision and a known ADAS technique, and that meets functional safety standards (for example, see Patent Literature 1).

In addition, a technique has been disclosed that includes detection means, automated driving means, determination means, and safety zone calculation means. The detection means acquires a traveling state of a vehicle, a surrounding situation of the vehicle, and a state of a driver. The automated driving means automatically drives the vehicle. The determination means determines whether or not a condition for performing the automated driving is satisfied. The determination means determines that the condition for performing the automated driving is not satisfied in a case where a detection accuracy of the detection means does not satisfy a predetermined criterion, and performs a notification that prompts the driver to cancel the automated driving in a case where the condition for performing the automated driving is determined as not being satisfied during the automated driving. The safety zone calculation means periodically calculates a stop point at which the vehicle is stoppable safely during the automated driving. The technique guides the vehicle to the stop point and stops the vehicle in a case where the driver does not cancel the automated driving even when performing the notification that prompts the cancellation of the automated driving (for example, see Patent Literature 2).

### CITATION LIST

### Patent Literature

Patent Literature 1: Japanese Unexamined Patent Application Publication (Translation of PCT Application) No. 2021-508863

Patent Literature 2: Japanese Unexamined Patent Application Publication No. 2014-106854

### SUMMARY OF INVENTION

### Problem to be Solved by the Invention

However, a technique described in Patent Literature 1 aims at constructing a platform that satisfies functional safety standards by providing diversity and redundancy in components including an architecture for an automated driving vehicle that utilizes an ADAS technique, and does not address a problem of how to continue an automated driving control or a driving assist control by mutually compensating characteristics of respective elements and devices that provide information necessary for performing the automated driving control or the driving assist control.

On the other hand, a sensor such as a LIDAR, which is a key part of the automated driving control, is excellent in detecting features, a road shape, etc., around the vehicle, but has a problem in that a detection accuracy in an area in front of a vehicle or an area away from the vehicle is reduced.

In addition, there has been a problem that, with only a sensor such as the LIDAR, for example, in a situation in which a front vehicle or the like is stagnant, such as a congestion section, the front vehicle or the like serves as a shielding object, and thus, it is not possible to acquire information related to traveling in the congestion section or a congestion solved section, and it is not possible to continue the automated driving control or the driving assist control.

The invention has been made in view of the problems described above, and it is therefore an object of the invention to provide a driving control system that supplements a function of a sensing device or the like used for an automated driving control and allows the automated driving control or a driving assist control to be continued.

### Means for Solving the Problem

Aspect 1: One or more embodiments of the invention propose a driving control system including: a sensor group for executing a driving assist; an automated driving control information generator that includes an automated driving sensor for executing an automated driving control, and is configured to generates information to be used for the automated driving control: a surrounding information generator configured to execute a communication connecting an own vehicle and everything, transmit automated driving sensor information of the own vehicle, and acquire automated driving sensor information of another vehicle to generate information on a surrounding of the own vehicle by the acquired information and a high-precision map: and a controller configured to execute the automated driving control or a driving assist control. The controller is configured to change a mode of a driving control in response to an operation state of the sensor group, the automated driving control information generator, or the surrounding information generator.

Aspect 2: One or more embodiments of the invention propose the driving control system in which, the controller is configured to, when the communication is disrupted, execute the automated driving control mainly based on information from the sensor group while referring to the information generated in the automated driving control information generator.

Aspect 3: One or more embodiments of the invention propose the driving control system in which, the controller is configured to, when the sensor for executing the automated driving control does not operate or does not function, execute the driving assist control mainly based on information from the sensor group while referring to the information generated in the surrounding information generator.

Aspect 4: One or more embodiments of the invention propose the driving control system in which, the controller is configured to, when the sensor group does not operate or does not function, execute the driving assist control mainly based on the information from the automated driving control information generator while referring to the information generated in the surrounding information generator.

Aspect 5: One or more embodiments of the invention propose the driving control system in which, the controller is configured to, when the communication is disrupted and where the sensor for executing the automated driving control does not operate or does not function, execute the driving assist control based on information from the sensor group.

Aspect 6: One or more embodiments of the invention propose the driving control system in which the controller includes: a processor inside a device provided in the own vehicle; and a server on cloud, and the server is configured to execute an advanced functional control of the own vehicle and a group control for a future prediction.

### Effects of the Invention

One or more embodiments of the invention have an effect in which it is possible to supplement a function, etc., of a sensing device used for an automated driving control and allow the automated driving control or a driving assist control to be continued.

### BRIEF DESCRIPTION OF DRAWINGS

FIG. 1 is a diagram illustrating a configuration of a driving control system according to a first embodiment of the invention.

FIG. 2 is a diagram illustrating a configuration of a controller of the driving control system according to the first embodiment of the invention.

FIG. 3 is a diagram illustrating an image of a driving control in normal times of the driving control system according to the first embodiment of the invention.

FIG. 4 is an image diagram in a case where a driving control is to be performed on the basis of information from a sensor group and a surrounding information generator of the driving control system according to the first embodiment of the invention.

FIG. 5 is an image diagram in a case where a driving control is to be performed on the basis of information from the sensor group and an automated driving control information generator of the driving control system according to the first embodiment of the invention.

FIG. 6 is an image diagram in a case where a driving control is to be performed on the basis of information from the sensor group of the driving control system according to the first embodiment of the invention.

FIG. 7 is an image diagram in a case where a driving control is to be performed on the basis of information from the automated driving control information generator of the driving control system according to the first embodiment of the invention.

FIG. 8 is a diagram illustrating a configuration of a controller of the driving control system according to a second embodiment of the invention.

FIG. 9 is a diagram illustrating an example of a traffic control of the controller of the driving control system according to the second embodiment of the invention.

FIG. 10 is a diagram illustrating an example of an external control of the controller of the driving control system according to the second embodiment of the invention.

FIG. 11 is a diagram illustrating an example of the external control of the controller of the driving control system according to the second embodiment of the invention.

### MODES FOR CARRYING OUT THE INVENTION

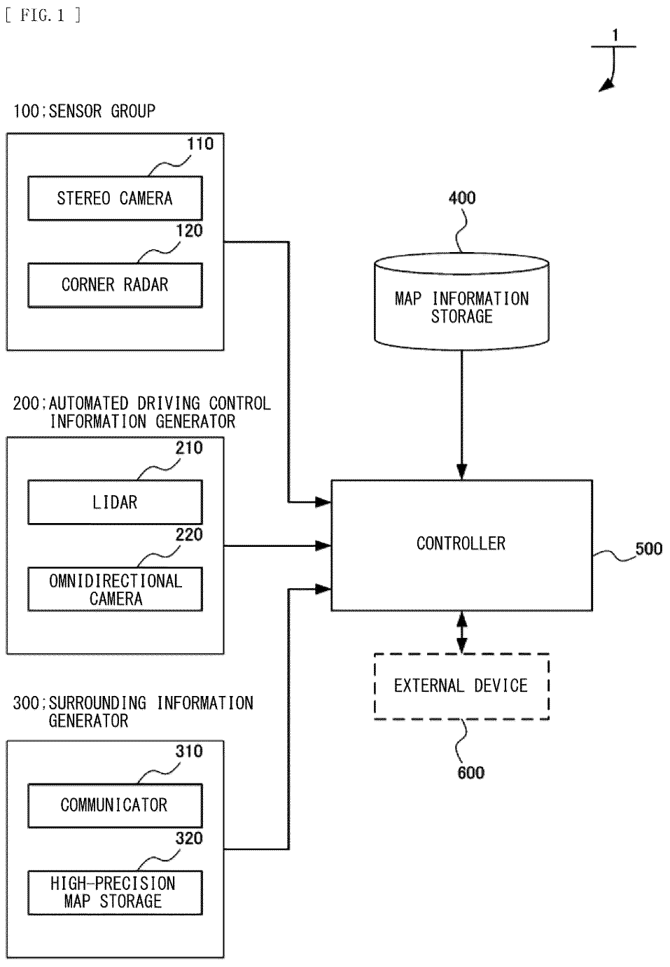

In the following, embodiments of the invention are described with reference to FIGS. 1 to 11.

### First Embodiment

Described is a driving control system 1 according to the present embodiment with reference to FIGS. 1 to 7.

### <Configuration of Driving Control System 1>

As illustrated in FIG. 1, the driving control system 1 according to the present embodiment includes a sensor group 100, an automated driving control information generator 200, a surrounding information generator 300, a map information storage 400, and a controller 500.

The driving control system 1 according to the present embodiment has a redundancy of a sensor, and combines information on a distant part of an own vehicle such as, for example, acceleration deceleration information determined from another vehicle, a person, a road situation (construction, a disabled vehicle), or a surrounding vehicle and information on a surrounding of the own vehicle by an autonomous sensor including the sensor group 100 and the automated driving control information generator 200 to execute, for example, a vehicle control that prevents vehicles from colliding with each other.

The sensor group 100 is a sensor for executing a driving assist, and includes, for example, a stereo camera 110 and a corner radar 120 as illustrated in FIG. 1.

It should be noted that information obtained by the sensor group 100 is outputted to the controller 500 to be described later.

The stereo camera 110 is a sensor that is able to perform a distance measurement as well as an image acquisition, and recognizes, for example, an object in front of the vehicle in a three-dimensional manner, and senses a type, a distance, a moving speed, etc., thereof.

Accordingly, by using the stereo camera 110, it is possible to distinguish a person, an object, a vehicle, a road shape such as a white line or a curve, etc.

It should be noted that, although the stereo camera 110 detects an object in front of the vehicle, a field of view is limited, and the stereo camera 110 mounted on the vehicle has an excellent recognition accuracy up to a medium distance in front of the vehicle and has an inferior recognition accuracy around the vehicle due to a relationship such as an installation position of the stereo camera 110 in the vehicle.

The corner radar 120 includes, for example, a millimeter wave radar, and is a sensor that detects an obstacle or the like at a close distance from the vehicle. The corner radar 120 is mainly mounted inside front and rear bumpers, and is used to, for example, provide a warning to an occupant about parking, approaching of a vehicle, etc., upon parking, approaching of the vehicle, etc.

The automated driving control information generator 200 includes an automated driving sensor for executing an automated driving control, and generates information to be used for the automated driving control. Here, as the automated driving sensor for executing the automated driving control, it is possible to exemplify a LIDAR 210, an omnidirectional camera 220, etc., as illustrated in FIG. 1.

It should be noted that the automated driving control information generated by the automated driving control information generator 200 is outputted to the later-described controller 500.

As one of remote sensing techniques using light, the LIDAR (Light Detection and Ranging, Laser Imaging Detection and Ranging) 210 measures scattered light with respect to application of a laser emitted in a pulsed fashion, and analyzes a distance to a target and a property of the target. The LIDAR 210 is equipped in addition to a camera and a millimeter wave radar in order to ensure a redundancy of sensing in order for the vehicle to autonomously travel safely on a freeway and a general road.

It should be noted that the LIDAR 210 is common to the stereo camera 110 as a sensor that outputs a distance point group. However, the stereo camera 110 is a passive sensor while the LIDAR 210 is an active sensor, thereby establishing a relationship that supplements each other with respect to the brightness and a sampling rate of an environment outside the vehicle.

The surrounding information generator 300 executes a communication connecting the vehicle and everything, transmits the automated driving sensor information of the own vehicle, and acquires automated driving sensor information of another vehicle to generate information on a surrounding of the own vehicle by the acquired information and a high-precision map.

Specifically, as illustrated in FIG. 1, for example, the surrounding information generator 300 includes a communicator 310 and a high-precision map storage 320. It should be noted that the surrounding information generated by the surrounding information generator 300 is outputted to the later-described controller 500.

Here, the “communication connecting the vehicle and everything” refers to, for example, a cellular V2X communication, a communication form in which 4G or 5G network access technology and a narrow-area communication (DSRC) technology are integrated, or a communication form in which the 4G or 5G network access technology, the narrow-area communication (DSRC) technology, and further the cellular V2X (C-V2X) communication technology are integrated.

The communicator 310 causes the vehicle to function as an ICT (Information and Communication Technology) terminal, and specifically, executes, for example, the communication connecting the vehicle and everything.

The surrounding information generator 300 generates surrounding information as information on a high-precision map by using the high-precision map stored in the high-precision map storage 320, on the basis of the information acquired by, for example, the communication connecting the vehicle and everything by the communicator 310.

It should be noted that the acquisition of the surrounding information using the communicator 310 is characterized in that the surrounding information in a distant region in a traveling direction of the vehicle is excellent in terms of accuracy and response, but for a short distance region of the vehicle, although there is no change in the accuracy of the information, there is a possibility that a response is delayed due to an external factor such as a communication environment.

The map information storage 400 stores information on the high-precision map.

Specifically, the map information storage 400 is configured by a hard disk device or a semiconductor memory, and stores map information of the high-precision map.

It should be noted that the information on the high-precision map stored in the map information storage 400 is read by the later-described controller 500.

The controller 500 executes the automated driving control or the driving assist control. Specifically, the controller 500 changes a driving control mode in response to an operation state of the sensor group 100, the automated driving control information generator 200, or the surrounding information generator 300.

Here, the “operation state” includes a normal operation, an abnormal operation, and a non-operation.

It should be noted that the controller 500 takes into consideration characteristics of the sensor group 100, the automated driving control information generator 200, and the surrounding information generator 300, and even in a case where these all operate normally, the controller 500 preferentially adopts sensor information up to the medium distance in front of the vehicle for the sensor information from the sensor group 100, preferentially adopts the automated driving control information around the vehicle for the automated driving control information from the automated driving control information generator 200, and preferentially adopts the surrounding information in the distant region in the traveling direction of the vehicle for the information from the surrounding information generator 300, thereby executing a further advanced driving control.

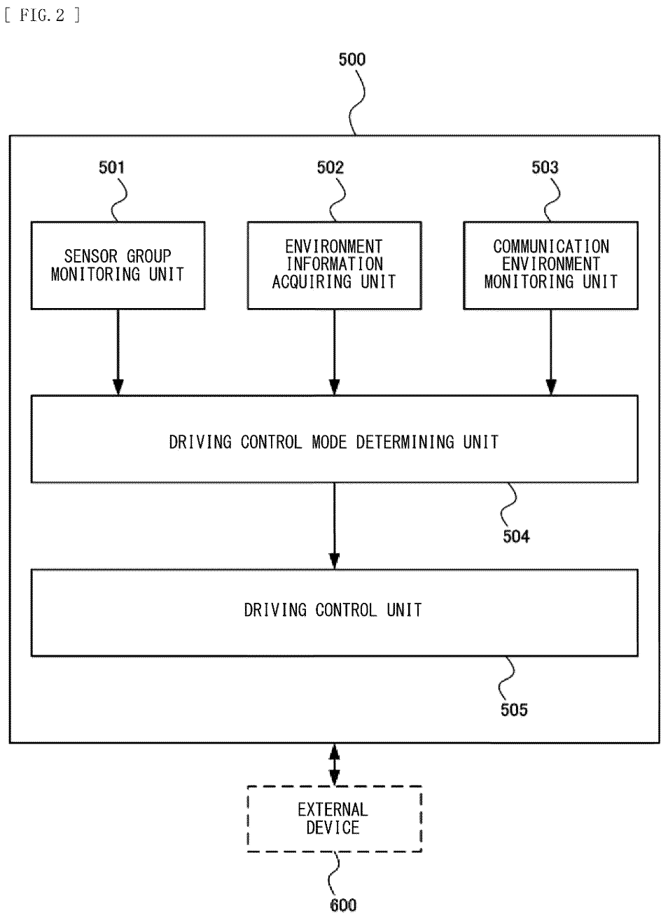

As illustrated in FIG. 2, the controller 500 includes a sensor group monitoring unit 501, an environment information acquiring unit 502, a communication environment monitoring unit 503, a driving control mode determining unit 504, and a driving control unit 505.

The sensor group monitoring unit 501 monitors the operation state of the sensor group 100 by monitoring sensing information received from the sensor group 100. It should be noted that, in a case where the sensor group monitoring unit 501 detects an abnormality in the operation state of the sensor group 100, the sensor group monitoring unit 501 outputs, to the later-described driving control mode determining unit 504, a signal indicating that the abnormality of the operation state of the sensor group 100 is detected.

The environment information acquiring unit 502 acquires, for example, information on a vehicle traveling area including weather information, etc., from an external device 600. The environment information acquired by the environment information acquiring unit 502 is outputted to the later-described driving control mode determining unit 504.

The communication environment monitoring unit 503 monitors a communication environment on a vehicle travel route from the external device 600, for example. It should be noted that, in a case where the communication environment monitoring unit 503 detects that the communication is disrupted or that there is a possible disruption of the communication, the communication environment monitoring unit 503 outputs, to the later-described driving control mode determining unit 504, a signal indicating that the communication is disrupted or there is a possible disruption of the communication.

The driving control mode determining unit 504 determines the driving control mode on the basis of the information received from the sensor group monitoring unit 501, the environment information acquiring unit 502, or the communication environment monitoring unit 503. Specifically, the driving control mode determining unit 504 determines a further advanced driving control mode that is available using a functional element that operates normally among the sensor group 100, the automated driving control information generator 200, and the surrounding information generator 300, and outputs a result of the determination to the later-described driving control unit 505.

It should be noted that, in the present embodiment, the driving control mode is advanced in the order of a driving assist control mode based on the automated driving control information from only the automated driving control information generator 200, a driving assist control mode based on the information from only the sensor group 100, a driving assist control mode based on the information from the sensor group 100 and the surrounding information from the surrounding information generator 300, a driving assist control mode based on the automated driving control information from the automated driving control information generator 200 and the surrounding information from the surrounding information generator 300, an automated driving control mode based on the information from the sensor group 100 and the automated driving control information from the automated driving control information generator 200, and an automated driving control mode based on the information from the sensor group 100, the automated driving control information from the automated driving control information generator 200, and the surrounding information from the surrounding information generator 300.

In addition, in a case where the automated driving control mode or the driving assist control mode is determined as being inexecutable, the driving control mode determining unit 504 outputs, to the driving control unit 505, a result of the determination that allows for execution of MRM (Minimal Risk Maneuver).

The driving control unit 505 executes a driving control of the vehicle on the basis of the determination result inputted from the driving control mode determining unit 504.

### <Driving Control in Normal Times>

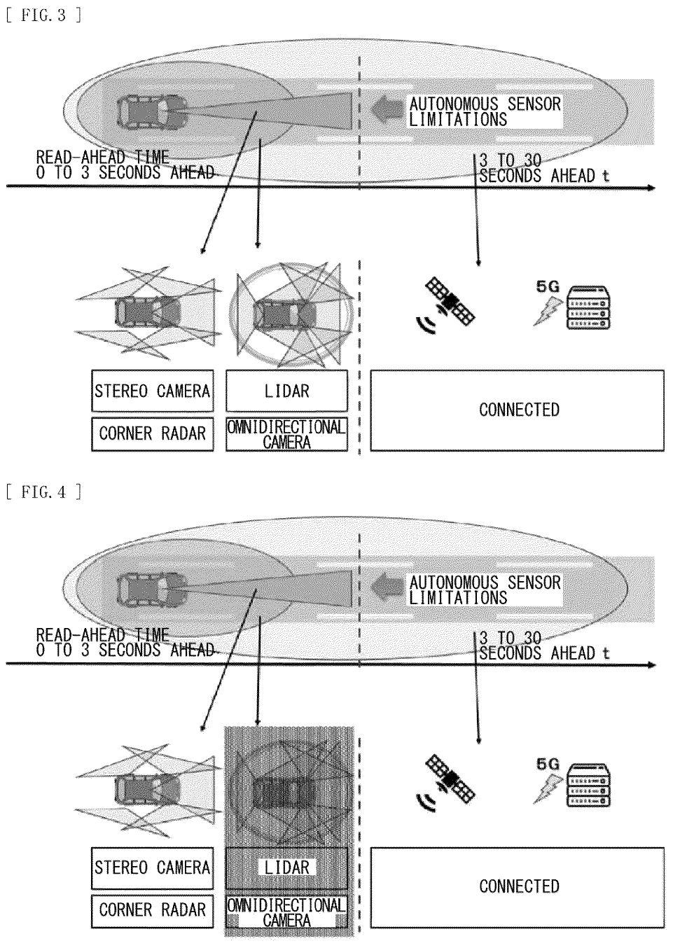

As illustrated in FIG. 3, in normal times, the driving control system 1 is configured such that the sensor group 100, the automated driving control information generator 200, and the surrounding information generator 300 each function normally.

In the driving control system 1, the sensor group 100 and the automated driving control information generator 200 perform sensing from a vehicle surrounding to a location in a medium distance in front of the vehicle, and the controller 500 mainly executes an advanced automated driving control on the basis of the automated driving control information from the automated driving control information generator 200 and the surrounding information from the surrounding information generator 300.

Specifically, the driving control system 1 is able to acquire in advance information on, for example, about 3 seconds to 30 seconds ahead of the current time by combining the sensor group 100, the automated driving control information generator 200, and the surrounding information generator 300, and therefore executes the automated driving control for a plurality of lanes including, for example, automated lane changes.

<Driving Control in Case where Automated Driving Control Information Generator 200 is in Non-Operation or in Abnormal Operation>

As illustrated in FIG. 4, in this case, the driving control system 1 is configured such that the sensor group 100 and the surrounding information generator 300 function normally.

Here, the automated driving control information generator 200 is in the non-operation or in the abnormal operation refers to a case where, for example, the sensing information from the LIDAR 210 is unable to be acquired due to bad weather such as snow or dense fog, or the sensing information is able to be acquired but an accuracy is low.

In the driving control system 1, the sensor group 100 performs sensing to the location in the medium distance in front of the vehicle, and the controller 500 executes the driving assist control on the basis of the sensing information from the sensor group 100 and the surrounding information from the surrounding information generator 300.

Specifically, the driving control system 1 executes, for example, a single-lane automated driving control that keeps the current lane on the basis of the sensing information from the sensor group 100, and also limits a vehicle speed, etc., from a line-of-sight distance based on the sensing information from the sensor group 100.

<Driving Control in Case where Surrounding Information Generator 300 is in Non-Operation or in Abnormal Operation>

As illustrated in FIG. 5, in this case, the driving control system 1 is configured such that the sensor group 100 and the automated driving control information generator 200 function normally.

Here, the surrounding information generator 300 is in the non-operation or in the abnormal operation refers to a case where, for example, the surrounding information is unable to be acquired due to the disruption of the communication, or the surrounding information is able to be acquired but a delay is occurred.

In the driving control system 1, the controller 500 executes an automated control on the basis of the sensing information from the vehicle surrounding to the location in the medium distance in front of the vehicle obtained by the sensor group 100 and the automated driving control information generator 200.

Specifically, the driving control system 1 executes, for example, the single-lane automated driving control that keeps the current lane on the basis of the sensing information from the sensor group 100 and the automated driving control information generator 200, and also limits the vehicle speed, etc., from the line-of-sight distance based on the sensing information from the sensor group 100. Further, the driving control system 1 changes a route design within a range of performance of the sensor group 100 and the automated driving control information generator 200.

<Driving Control in Case where Surrounding Information Generator 300 is in Non-Operation or in Abnormal Operation and where Automated Driving Control Information Generator 200 is in Non-Operation or in Abnormal Operation>

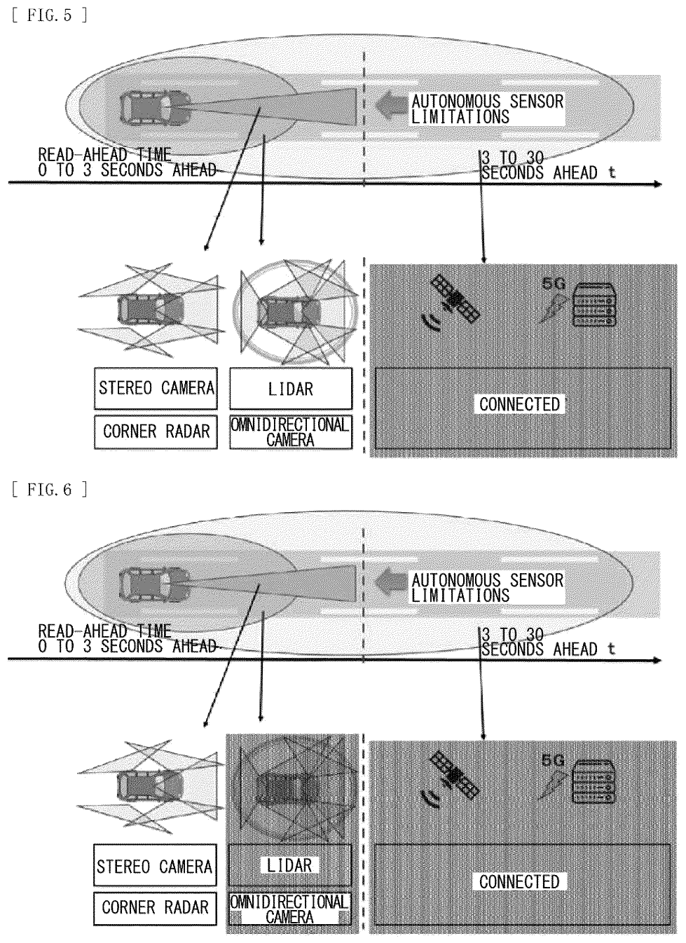

As illustrated in FIG. 6, in this case, the driving control system 1 is configured such that only the sensor group 100 functions normally.

In the driving control system 1, the sensor group 100 performs the sensing to the location in the medium distance in front of the vehicle, and the controller 500 executes the driving assist control on the basis of the sensing information.

Specifically, the driving control system 1 executes, for example, the single-lane automated driving control that keeps the current lane on the basis of the sensing information from the sensor group 100, and also limits the vehicle speed, etc., from the line-of-sight distance based on the sensing information from the sensor group 100.

<Driving Control in Case where Surrounding Information Generator 300 is in Non-Operation or in Abnormal Operation and where Sensor Group 100 is in Non-Operation or in Abnormal Operation>

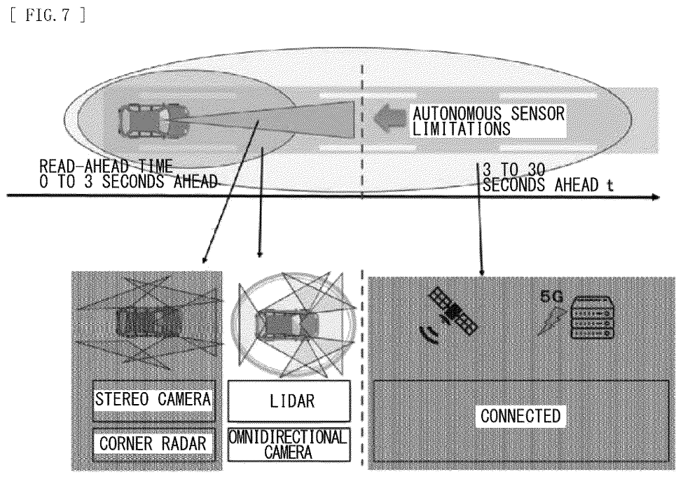

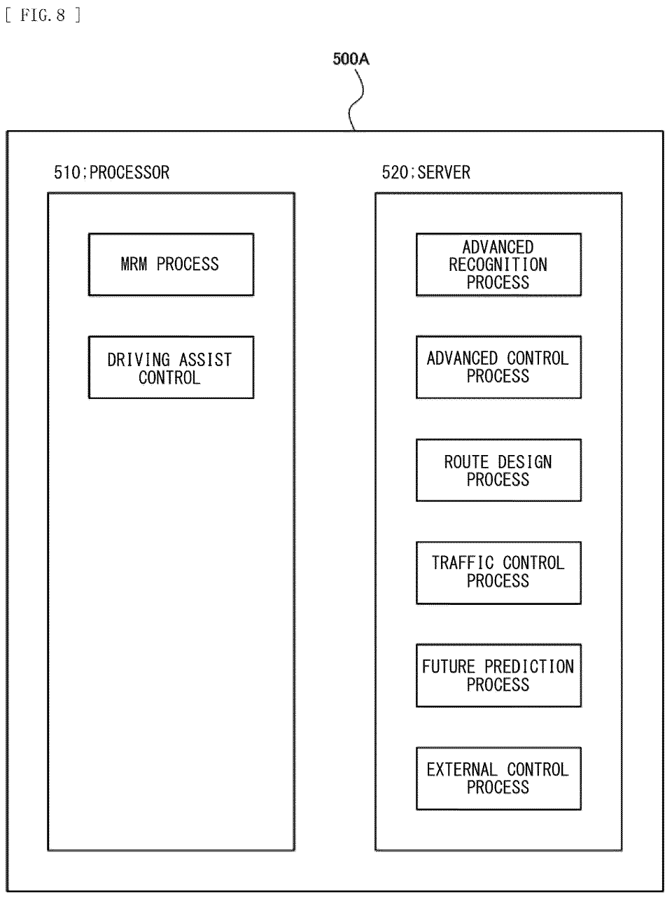

As illustrated in FIG. 7, in this case, the driving control system 1 is configured such that only the automated driving control information generator 200 functions normally.

Here, the sensor group 100 is in the non-operation or in the abnormal operation refers to a case where, for example, the sensing information from the stereo camera 110 is unable to be acquired due to nighttime, backlight, or bad weather such as dense fog, but the accuracy is low.

In the driving control system 1, the automated driving control information generator 200 performs sensing of the vehicle surrounding, and the controller 500 executes the driving assist control on the basis of the sensing information.

Specifically, the driving control system 1 executes, for example, the single-lane automated driving control that keeps the current lane on the basis of the sensing information from the automated driving control information generator 200.

### <Workings and Effects>

As described in the foregoing, the driving control system 1 according to the present embodiment includes: the sensor group 100 for executing the driving assist: the automated driving control information generator 200 that includes an automated driving control sensor for executing the automated driving control and generates information to be used for the automated driving control: the surrounding information generator 300 that executes the communication connecting the vehicle and everything, transmits the automated driving sensor information of the own vehicle, and acquires the automated driving sensor information of another vehicle to generate the information on the surrounding of the own vehicle by the acquired information and the high-precision map: and the controller 500 that executes the automated driving control or the driving assist control. The controller 500 changes the mode of the driving control in response to the operation state of the sensor group 100, the automated driving control information generator 200, or the surrounding information generator 300.

That is, a function of a sensing device used for the automated driving control is supplemented to perform the advanced automated driving control in normal times.

On the other hand, even in a situation where at least one of the sensor group 100, the automated driving control information generator 200, or the surrounding information generator 30 does not operate in the normal operation, a functional block that operates in the normal operation is used to allow the automated driving control or the driving assist control to be continued.

Accordingly, in a case where at least one of the sensor group 100, the automated driving control information generator 200, or the surrounding information generator 300 is in the normal operation, it is possible to allow the automated driving control or the driving assist control to be continued.

### Second Embodiment

A driving control system 1A according to the present embodiment will be described with reference to FIG. 8 to FIG. 11.

### <Configuration of Driving Control System 1A>

The driving control system 1A according to the present embodiment includes the sensor group 100, the automated driving control information generator 200, the surrounding information generator 300, the map information storage 400, and a controller 500A.

It should be noted that, because elements denoted with the same reference numerals as the first embodiment have similar functions, a detailed description thereof will be omitted.

As illustrated in FIG. 8, the controller 500A includes a processor 510 mounted in the vehicle and a server 520 provided outside, and executes the automated driving control or the driving assist control of the vehicle.

As illustrated in FIG. 8, the processor 510 executes an MRM process and a driving assist control process.

Here, the MRM process is a process that safely stops the vehicle at a safe location detected in advance in a case where the execution of the automated driving control or the driving assist control is not possible. Further, the driving assist control process is, for example, a process that assists driving to keep the current lane on the basis of the sensing information from the sensor group 10.

On the other hand, as illustrated in FIG. 8, the server 520 executes an advanced recognition process, an advanced control process, a route design process, a traffic control process, a future prediction process, an external control process, etc.

Here, the advanced recognition process is, for example, an advanced object recognition, etc., based on image processing, etc.

The advanced control process is, for example, a process related to the advanced automated driving control, etc., and is a process in a system that ensures a redundancy of a control system and a sensor system.

The route design process is, for example, a process designing a route that reflects characteristics and a state of the driver. It should be noted that, in a case of a system configuration in which a server that recognizes the characteristics and the state of the driver and a server that performs the route design are provided separately, a control process between the servers is also included.

The traffic control process is a process that aggregates information of each vehicle and executes a control appropriate to the own vehicle on the basis of these pieces of information.

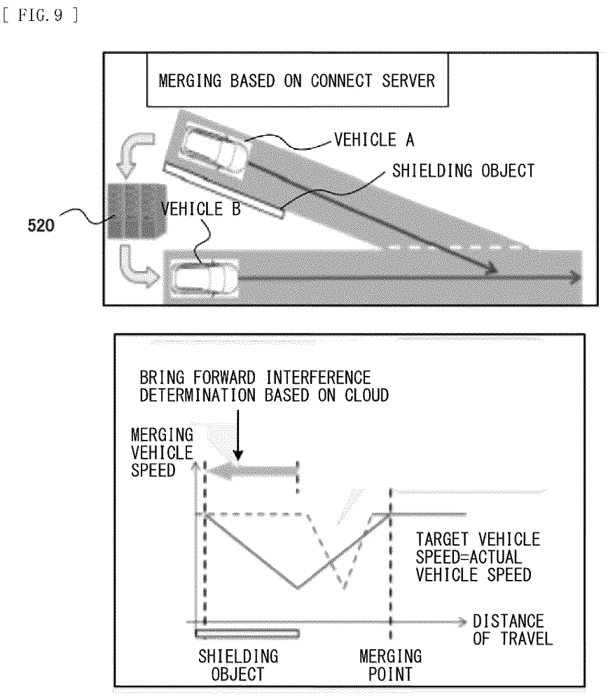

For example, FIG. 9 illustrates an example of a control of the vehicles at a merging point with poor visibility.

An upper diagram of FIG. 9 illustrates a state of merging between a vehicle A and a vehicle B. Further, a lower diagram of FIG. 9 is a graph in which a vertical axis represents a vehicle speed and a horizontal axis represents a traveling distance, and in which a dotted line represents acceleration/deceleration of the vehicle A and a solid line represents acceleration/deceleration of the vehicle B. As illustrated in the upper diagram of FIG. 9, the vehicle A travels along a shielding object by which the vehicle B is not recognizable, and travels toward the merging point. Because the vehicle A travels without being able to recognize the vehicle B in a section where the shielding object is present, the vehicle A travels without decelerating, and recognizes the vehicle A and rapidly decelerates temporarily at a point where the shielding object ends, and then the vehicle A rapidly accelerates to reach the merging point.

On the other hand, because the vehicle B travels on the basis of control information from the server 520 that has received traveling position information and traveling speed information of the vehicle A, the vehicle B gradually decelerates in the section where the shielding object is present, and when the vehicle B passes through the section where the shielding object is present, the vehicle B gradually accelerates and smoothly merges at the merging point.

The future prediction process is, for example, a process that recognizes a natural congestion prediction, a construction section, and a road closed section in front of a traveling route on the basis of information from another vehicle, and reflects the recognition in the route design process, etc.

The external control process refers to, for example, a process related to automated parking or a process that is special and has a large processing load.

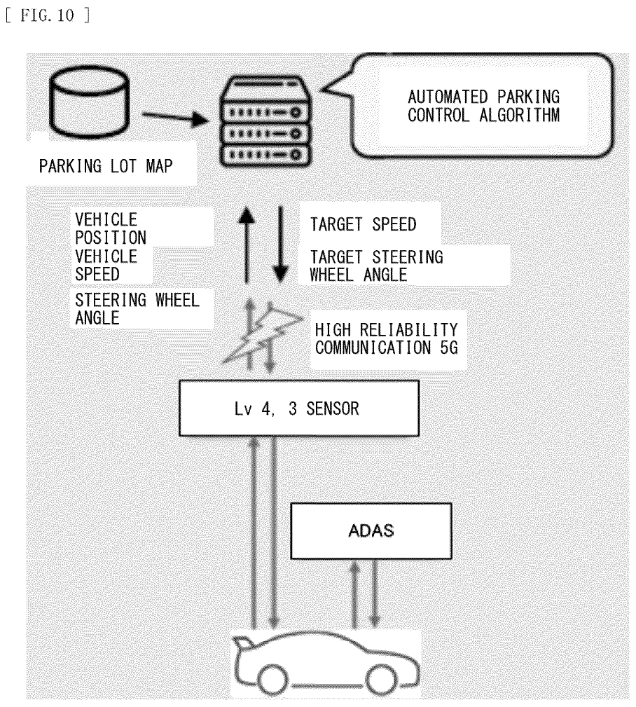

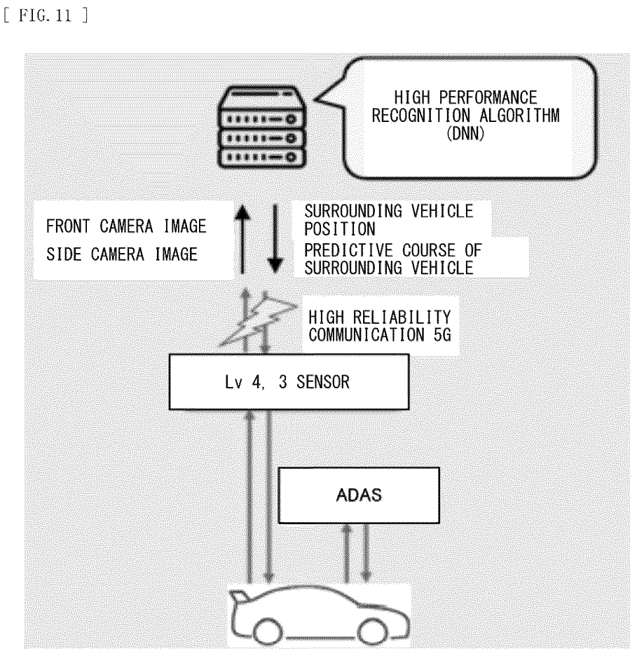

In the process related to automated parking as illustrated in FIG. 10, for example, local map information used in a scene where the vehicle is to be parked at a parking lot of a supermarket or an algorithm of a control system to be used only in the scene are not mounted on the vehicle side but is mounted on the server 520.

Specifically, in the process related to the automated parking, for example, using automated parking control algorithm mounted on the server 520 and map information of the parking lot, an automated parking control is executed by transmitting information such as a target speed or a target steering wheel angle to the processor 510 of the vehicle with respect to vehicle position information, vehicle speed information, steering wheel angle information, etc., received from the vehicle.

Further, in a high-load process illustrated in FIG. 11, such as a vehicle recognition in a snowstorm or an image recognition in a special and highly processing-loaded scene where a large number of people and vehicles travel in a mixed manner, an image captured by the vehicle side is sent to the server 520, and a high-performance recognition process (DNN) is performed in the server 520, and a result thereof is transmitted to the processor 510 on the vehicle side.

Specifically, the server 520 receives, for example, a camera image in front of the vehicle and a camera image in rear of the vehicle from the vehicle side, analyzes these images by the high-performance recognition algorithm (DNN), and outputs surrounding vehicle position information, surrounding vehicle predicted course information, etc., to the processor 510 on the vehicle side.

### <Workings and Effects>

As described in the foregoing, the controller 500A of the driving control system 1A according to the present embodiment includes the processor 510 mounted in the vehicle and the server 520 provided outside, and executes the automated driving control or the driving assist control of the vehicle. In addition, the processor 510 executes the MRM process and the driving assist control process, and the server 520 executes the advanced recognition process, the advanced control process, the route design process, the traffic control process, the future prediction process, the external control process, etc.

That is, the processor 510 executes a low-load process, and the server 520 performs a high-load process and an advanced process such as the traffic control, and a process related to an event with low frequency.

Therefore, the server 520 having a high processing capability and the processor 510 having a low processing capability make it possible to maintain a real-time performance of a control even for high-load and advanced processing by distributing processes on the basis of processing capabilities thereof. Accordingly, it is possible to supplement a function of a sensing device used for the automated driving control and allow the automated driving control or the driving assist control to be continued.

### Modification Example 1

The server 520 may be configured by a plurality of servers such as a traffic control server that performs a process of a control system or an individual vehicle server that collects vehicle data, manages a state of the vehicle, and estimates a control parameter on the basis of characteristics of the driver.

In addition, the server 520 may be configured by a plurality of servers such as a recognition server, a route design server, a MEC, Wavelength (registered trademark), and a net server, for each function.

As described above, by dividing the servers by a type of the control and the function, it is possible to maintain a real-time performance of a control even for high-load and advanced processing. Accordingly, it is possible to supplement a function of a sensing device used for the automated driving control and allow the automated driving control or the driving assist control to be continued.

### Modification Example 2

In addition, a server to be communicably connected may be flexibly changed on the basis of a control level.

For example, in a case where a connection of a communication with a certain server becomes unable due to the disruption of the communication, the connection may be made to another backup server in order to continue the automated driving control or the driving assist control.

In addition, in a case where the disruption of the communication is solved, a server to be connected may be selected on the basis of the control level.

Thus, it is possible to maintain a real-time performance of a control even for high-load and advanced processing. Accordingly, it is possible to supplement a function of a sensing device used for the automated driving control and allow the automated driving control or the driving assist control to be continued.

It should be noted that is possible to implement the driving control system 1 of the invention by recording the process to be executed by the controller 500 or 500A on a recording medium readable by a computer system, and causing the computer system to load the program recorded on the recording medium onto the controller 500 or 500A to execute the program. The computer system as used herein encompasses an OS and a hardware such as a peripheral device.

In addition, in a case where the computer system utilizes WWW (World Wide Web) system, the “computer system” shall encompass a website providing environment (or a website displaying environment). Further, the program may be transmitted from a computer system that contains the program in a storage device or the like to another computer system via a transmission medium or by a carrier wave in a transmission medium. The “transmission medium” that transmits the program refers to a medium having a function of transmitting information, including a network (a communication network) such as the Internet and a communication link (a communication line) such as a telephone line.

Further, the program may be directed to implement a part of the function described above. Moreover, the program may be a so-called differential file (differential program) configured to implement the function by a combination of a program already recorded on the computer system.

Although embodiments of the invention have been described in the foregoing with reference to the drawings, a specific configuration is not limited to that of the embodiment, and a design, etc., within the scope that does not depart from the gist of the invention shall be included as well.

### DESCRIPTION OF REFERENCE NUMERALS

1: Driving control system
1A: Driving control system
100: Sensor group
110: Stereo camera
120: Corner radar
200: Automated driving control information generator
210: LIDAR
220: Omnidirectional camera
300: Surrounding information generator
310: Communicator
320: High-precision map storage
400: Map information storage
500: Controller
500A: Controller
501: Sensor group monitoring unit
502: Environment information acquiring unit
503: Communication environment monitoring unit
504: Driving control mode determining unit
505: Driving control unit

1. A driving control system comprising:
a sensor group for executing a driving assist;
an automated driving control information generator that includes an automated driving sensor for executing an automated driving control, and is configured to generate information to be used for the automated driving control;
a surrounding information generator configured to execute a communication connecting an own vehicle and everything, transmit automated driving sensor information of the own vehicle, and acquire automated driving sensor information of another vehicle to generate information on a surrounding of the own vehicle by the acquired information and a high-precision map; and
a controller configured to execute the automated driving control or a driving assist control, wherein
the controller is configured to change a mode of a driving control in response to an operation state of the sensor group, the automated driving control information generator, or the surrounding information generator.

2. The driving control system according to claim 1, wherein, the controller is configured to, when the communication is disrupted, execute the automated driving control mainly based on information from the sensor group while referring to the information generated in the automated driving control information generator.

3. The driving control system according to claim 1, wherein, the controller is configured to, when the sensor for executing the automated driving control does not operate or does not function, execute the driving assist control mainly based on information from the sensor group while referring to the information generated in the surrounding information generator.

4. The driving control system according to claim 1, wherein, the controller is configured to, when the sensor group does not operate or does not function, execute the driving assist control mainly based on the information from the automated driving control information generator while referring to the information generated in the surrounding information generator.

5. The driving control system according to claim 1, wherein, the controller is configured to, when the communication is disrupted and where the sensor for executing the automated driving control does not operate or does not function, execute the driving assist control based on information from the sensor group.

6. The driving control system according to claim 1, wherein
the controller comprises: a processor inside a device provided in the own vehicle; and a server on cloud, and
the server is configured to execute an advanced functional control of the own vehicle and a group control for a future prediction.
